(19) United States
(12) Patent Application Publication
(10) Pub. No.: US 2026/0135485 A1
(43) Pub. Date: May 14, 2026

(54) POWER CONVERTER

(71) Applicants: DENSO CORPORATION, Kariya-City (JP); TOYOTA JIDOSHA KABUSHIKI KAISHA, Toyota-Shi (JP); MIRISE Technologies Corporation, Nisshin-shi (JP)

(72) Inventor: Hideya MATSUNAGA, Nisshin-shi (JP)

(21) Appl. No.: 19/338,378

(22) Filed: Sep. 24, 2025

(30) Foreign Application Priority Data
Nov. 11, 2024 (JP) 2024-196686

(51) Int. Cl. H02M 3/158; H02M 3/00; H02M 7/5387

(52) U.S. Cl. CPC H02M 3/158; H02M 3/01; H02M 7/53871

(57) ABSTRACT

A power converter includes a power conversion unit and a controller. The power conversion unit includes legs. Each leg includes a first series connection of a high-potential side main switch and a low-potential side main switch, resonance capacitors, a power conversion unit, and a second series connection of two auxiliary switches and a resonance inductor. The resonance capacitors are connected to the high-potential side main switch and the low-potential side main switch in parallel, respectively. The controller controls switching of each switch included in the power conversion unit, controls each of the legs to execute soft switching, and corrects timing for switching the main switch or the auxiliary switch, such that an ON-time ratio of the main switch among the legs attains a predetermined ratio.

### CROSS REFERENCE TO RELATED APPLICATION

This application is based on Japanese Patent Application No. 2024-196686 filed on Nov. 11, 2024, the disclosure of which is incorporated herein by reference.

### TECHNICAL FIELD

The present disclosure relates to a power converter.

### BACKGROUND

A DC/DC converter circuit may have an Auxiliary Resonant Commutated Pole (ARCP) circuit. The ARCP-type circuit may include a controller and a storage. The controller may control main switches and resonant switches. The storage unit may store a calculation formula related to an operation timing for turning on the main switches.

### SUMMARY

The present disclosure describes a power converter that may include a power conversion unit and a controller, and further describes that the power conversion unit may include a first series connection of main switches and a second series connection of auxiliary switches.

### BRIEF DESCRIPTION OF DRAWINGS

FIG. 1 is a circuit diagram showing a power circuit of a power converter in a first embodiment.

FIG. 2 is a functional block diagram showing an overall configuration of the power converter.

FIG. 3 is a flowchart showing control contents.

FIG. 4 is a timing chart corresponding to the control contents shown in FIG. 3.

FIG. 5 is a circuit diagram showing a power circuit of a power converter in a second embodiment.

FIG. 6 is a functional block diagram showing the overall configuration of the power converter.

FIG. 7 is a flowchart showing control contents.

FIG. 8 is a timing chart corresponding to the control contents shown in FIG. 7.

FIG. 9 is a flowchart showing control contents in a third embodiment.

FIG. 10 is a timing chart corresponding to the control contents shown in FIG. 9.

FIG. 11 is a functional block diagram showing an overall configuration of a power converter in a fourth embodiment.

FIG. 12 is a flowchart showing control contents.

FIG. 13 is a timing chart corresponding to the control contents shown in FIG. 12.

FIG. 14 is a circuit diagram mainly showing the power circuit of the power converter in the case where three legs are connected in parallel.

### DETAILED DESCRIPTION

A DC/DC converter circuit may have an ARCP circuit. The ARCP circuit may include a controller and a storage. The controller may control main switches and resonant switches. The storage may store a calculation formula related to an operation timing for turning on the main switches. The controller may calculate a first time period from a time point of turning on the resonant switches to another time point of turning on the main switches based on the first calculation formula, may perform a switching process to turn on the main switches at the end of the first time period, and may carry out control to correct and update the first calculation formula so that a deviation between the timing at which the resonant current falls and the reactor current crosses (the crossing timing) and the operation timing is reduced.

In the above DC/DC converter circuit, control may be performed such that the main switch is turned on after the first time period has elapsed following the turning on of the resonant switch. The first time period may increase or decrease in proportion to the output current amount according to the first calculation formula. In the above DC/DC converter circuit, since there is only one leg of main switches, a delay caused by the first time period may not be an issue.

However, in an inverter circuit with, for example, a three-phase configuration, there is a possibility that the ON timing of the main switches in each leg may vary independently, resulting in difficulties with output control. That is, in three-phase AC, the line-to-line output voltage may be determined by the relative ON duty ratios of the U, V, and W phase pulses. Therefore, if there are differences in the resonance waiting times for each phase, the duty ratios may differ. As a result, voltage differences may arise between the three phases, or the maximum output may decrease.

According to a first aspect of the present disclosure, a power converter includes a power converter unit and a controller. The power converter unit includes legs. Each of the legs includes a first series connection of a high-potential side main switch and a low-potential side main switch, resonance capacitors and a second series connection of two auxiliary switches and a resonance inductor. The high-potential side main switch and the low-potential side main switch are collectively referred to as a main switch. The resonance capacitors are connected in parallel to the high-potential side main switch and the low-potential side main switch. The two auxiliary switches are two transistors that form a bidirectional switch. The two transistors have commonly connected drains or emitter. The second series connection has a first end and a second end. The first end is connected to a common connection node between the high-potential side main switch and the low-potential side main switch, and the second end is connected to a common node. The two auxiliary switches are collectively referred to as an auxiliary switch. The controller control switching of each switch included in the power conversion unit by: controlling each of the legs to execute soft switching; and correcting a timing for switching the main switch or the auxiliary switch, such that an ON-time ratio of the main switch among the legs attains a predetermined ratio.

With this configuration, even if it is expected that the timing at which the turning on of the main switches of each leg will be delayed from the intended timing due to the switching operation of the auxiliary switches, the controller corrects the timing so that the ON time ratio of the main switches among the respective legs becomes as intended. As a result, it is possible to control the difference in the voltages output by each leg of the power conversion unit so that the voltages coincide with the target value.

According to a second aspect of the present disclosure, the controller calculates a turn-on time and an ideal ON timing of the main switch to acquire a target output from the power conversion unit; controls switching of the main switch according to the turn-on time and the ideal ON timing; corrects an ON timing of the auxiliary switch, the ON timing being a preset timing; executes switching control of the auxiliary switch according to the corrected ON timing; calculates an ON timing delay time of the main switch according to a switching operation of the auxiliary switch; and corrects the ON timing of the auxiliary switch based on the calculated ON timing delay time.

Specifically, the controller calculates the ON timing delay time of the main switch corresponding to the switching operation of the auxiliary switch, and corrects the ON timing of the auxiliary switch based on this ON timing delay time. By performing such correction, the timing at which the main switch turns on can be advanced by the delay time, thereby coinciding it with the ideal ON timing.

According to a third aspect of the present disclosure, the controller detects an actual ON timing of the main switch in the power conversion unit; and executes an additional correction of the ON timing of the auxiliary switch, such that the actual ON timing coincides with the ideal ON timing. As a result, even if there is a difference between the actual ON timing and the ideal ON timing of the main switch after correction based on the calculated ON timing delay time, both timings can be controlled to coincide with each other through additional correction.

### First Embodiment

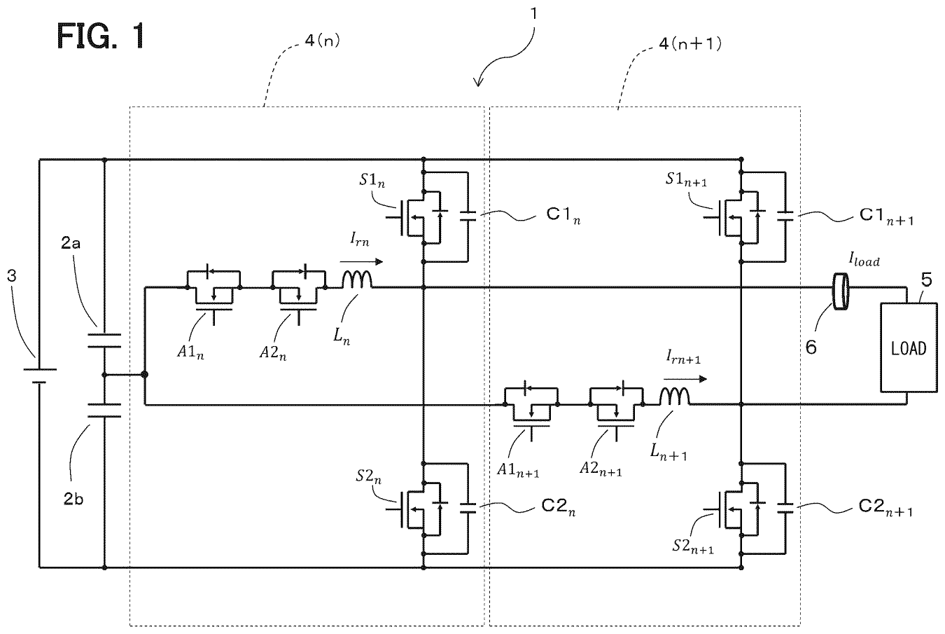

As shown in FIG. 1, an ARCP-type power circuit 1 of the present embodiment is connected in parallel with a DC power supply 3 and a series connection of capacitors 2a and 2b. In the power circuit 1, a leg 4(n) and a leg 4(n+1) are connected in parallel. The leg 4 includes: a first series connection of a high-potential side main switch S1 and a low-potential side main switch S2, which are connected in parallel to the DC power supply 3; and a second series connection of auxiliary switches A1 and A2 and an inductor L, which is connected between the intermediate node (i.e., neutral point) between the capacitors 2a and 2b and the common connection node between the main switches S1 and S2. In present disclosure, the first series connection corresponds to a series circuit in which the high-potential side main switch S1 and the low-potential side main switch S2 are connected in series, and the second series connection corresponds to a series circuit in which the auxiliary switches A1 and A2 and the inductor L are connected in series.

In the present embodiment, the main switches S1 and S2 and the auxiliary switches A1 and A2 are, for example, N-channel MOSFETs. It should be noted that the parasitic diodes of each FET are indicated by simplified symbols. The series connection of the auxiliary switches A1 and A2 functions as a bidirectional switch, and, for example, the auxiliary switches A1 and A2 are connected such that their sources or drains are common to each other. The capacitors C1 and C2, which include parasitic capacitance or additionally provided capacitance, are connected in parallel to the main switches S1 and S2, respectively.

A load 5 is connected between the common connection node between the main switches Sin and S2ₙ, which are the output terminals of the leg 4(n), and the common connection node between the main switches S1ₙ₊₁ and S2ₙ₊₁, which are the output terminals of the leg 4(n+1). A current sensor 6 is disposed between the output terminal of the leg 4(n) and the load 5. In other words, the current sensor 6 is connected between the output terminal of the leg 4(n) and the load 5.

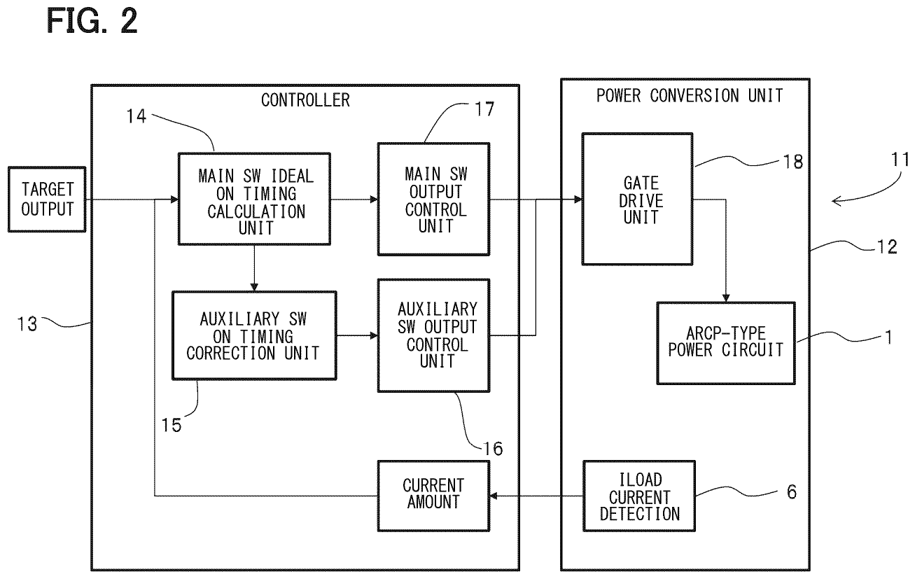

As shown in FIG. 2, the power converter 11 of the present embodiment includes a power conversion unit 12 and a controller 13. The controller described in the present disclosure may include a processor and a memory. The controller may execute the following functions (functional units) by executing a program stored in the memory through the processor. In additional, the controller 13 may include a hardware logic circuit that executes the following functions. Moreover, the controller may execute the following functions with the combination of the processor and the hardware logic circuit. The power conversion unit 12 includes the power circuit 1. The main SW ideal ON timing calculation unit 14 of the controller 13 receives, from a higher-level control unit (not shown), a target output, as well as the load current Iload detected by the current sensor 6. The main SW ideal ON timing calculation unit 14 calculates the ideal ON timing of the main switches S1 and S2 based on the input signals, and outputs the calculated ideal ON timing to the auxiliary SW ON timing correction unit 15 and the main SW output control unit 17.

The auxiliary SW ON timing correction unit 15 corrects the ON timing of the auxiliary switches A1 and A2 based on the input signals, and outputs the correction information to an auxiliary SW output control unit 16. The auxiliary SW output control unit 16 calculates the switching timing of the auxiliary switches A1 and A2 based on the above correction information, and outputs switching control signals to the gate drive unit 18 of the power conversion unit 12.

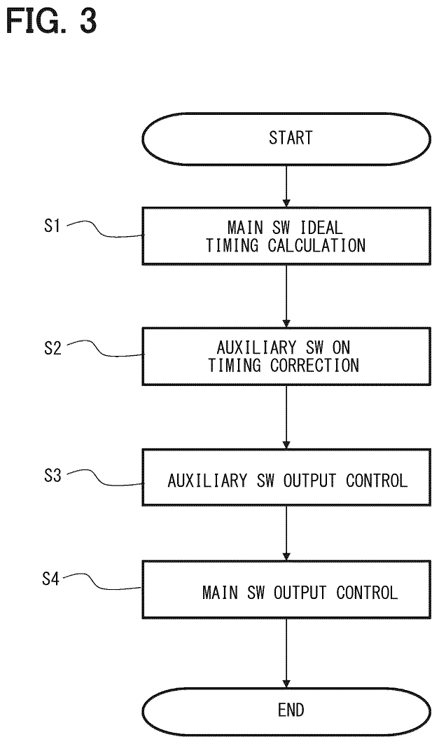

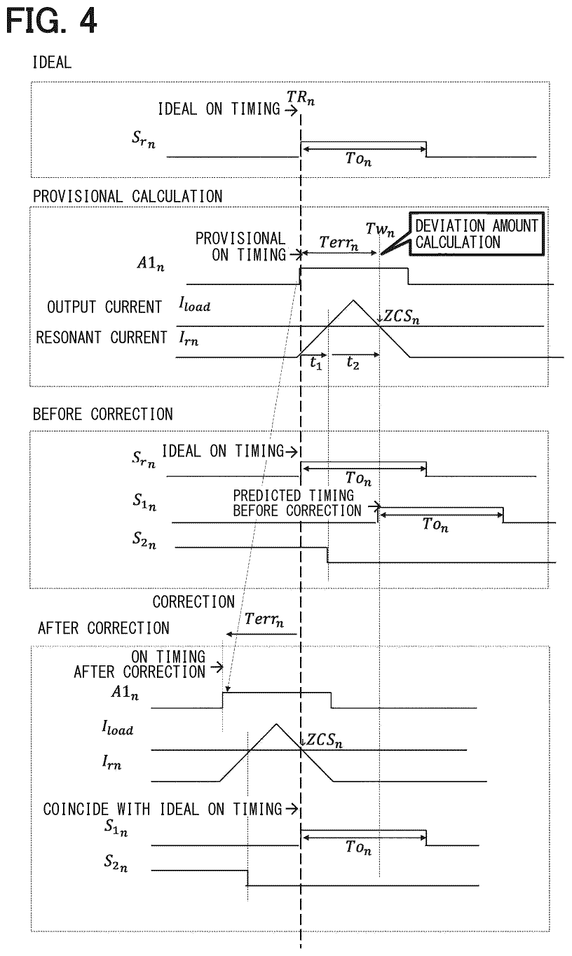

Next, the operation of the present embodiment will be described with reference to FIGS. 3 and 4. First, the main SW ideal ON timing calculation unit 14 of the controller 13 determines, for each leg 4, the ideal ON timing TRₙ and the ON time TOₙ of the main switches S1ₙ and S2ₙ required to achieve the target output in S1 shown in FIG. 3. Srₙ denotes the ideal switching waveform of the main switch S1ₙ as shown in FIG. 4. Here, the ideal ON timing refers to an arbitrary timing determined by the output control.

In addition, the provisional calculation of the optimal SW timing TWₙ is performed. The optimal SW timing TWₙ is the ON timing of the auxiliary switches A1n and A2n required to achieve soft switching of each leg 4 by zero current switching (ZCSₙ). The optimal SW timing TWₙ is calculated, for example, by estimating the resonant current Iₘ based on the output current I_{load} and the resonant inductor L and capacitance C in each leg 4, using the following equation (1). It should be noted that the optimal SW timing TWₙ here may also be determined using a pre-calculated and preset map. In the ARCP mode, when the polarity of the output current is positive, the auxiliary switch A1n conducts a positive current through the inductor L; and when the polarity of the output current is negative, the auxiliary switch A2n conducts a negative current through the inductor L. The following explanation will describe the case where the polarity of the output current is positive.

$${T}_{Wn} = {t}_{1} + {t}_{2} = \frac{{L}_{rn}}{{V}_{in} / 2} \cdot {I}_{load} + π \sqrt{2 {L}_{rn} {C}_{rn}} \qquad ( 1 )$$

Next, the auxiliary SW ON timing correction unit 15 calculates the difference Terrₙ between the ideal ON timing TRₙ required to achieve the target output and the provisionally calculated optimal SW timing TWₙ, and uses this value to correct the timing of the auxiliary switches A1ₙ and A2ₙ in S2 shown in FIG. 3. Then, the ON timing of the auxiliary switches A1ₙ and A2ₙ is corrected using the calculated correction value Terrₙ, and the auxiliary SW output control unit 16 performs the switching control of the auxiliary switches A1ₙ and A2ₙ in S3 shown in FIG. 3. The difference Terrₙ corresponds to a delay time.

Subsequently, the main SW output control unit 17 performs switching control of the main switches S1n and S2ₙ in S4 as shown in FIG. 3. As shown in the “after correction” timing chart in FIG. 4, by correcting the ON timing of the auxiliary switches A1n and A2n, the ON timing of the main switches Sin and S2ₙ coincides with the ideal ON timing. When the polarity of the output current is negative, similar control may be performed for the main switch S2 and the auxiliary switch A2.

As described above, according to this embodiment, the power circuit 1 of the power converter 11 includes multiple legs 4, each including: a series connection of the high-potential side main switch S1 and the low-potential side main switch S2; the resonant capacitors C1 and C2 respectively connected in parallel to the main switches S1 and S2; and a series connection of two auxiliary switches A1 and A2 and the resonant inductor L, with one end connected to the common connection node between the main switches S1 and S2 and the other ends commonly connected. The controller 13 controls each leg 4 to perform soft switching, and also corrects the switching timing of the auxiliary switches A1 and A2 so that the ON time ratios of the main switches S1 and S2 among the legs 4 become as intended.

With this configuration, even in a case where the ON timing of the main switches S1 and S2 in each leg 4 is expected to be delayed from the intended timing due to the switching operation of the auxiliary switches A1 and A2, the controller 13 can perform correction so that the ON time ratios of the main switches among the legs 4 become as intended, thereby allowing control such that the difference in the voltages output by each leg 4 reaches the target value.

Then, the main switch ideal ON timing calculation unit 14 of the controller 13 calculates the turn-on time TOₙ and the ideal ON timing TRₙ of the main switches S1 and S2 required to obtain the target output from the power conversion unit 12. The main switch output control unit 17 performs switching control of the main switches S1 and S2 in accordance with the turn-on time TOₙ and the ideal ON timing TRₙ. The auxiliary switch ON timing correction unit 15 corrects the preset ON timing of the auxiliary switches A1 and A2, and the auxiliary switch output control unit 16 performs switching control of the auxiliary switches A1 and A2 in accordance with the corrected ON timing.

The auxiliary switch ON timing correction unit 15 calculates the ON timing delay time Terrₙ of the main switches S1 and S2 corresponding to the switching operation of the auxiliary switches A1 and A2, and corrects the ON timing of the auxiliary switches A1 and A2 based on this ON timing delay time Terrₙ. By performing such correction, the timing at which the main switches S1 and S2 are turned ON can be advanced by the delay time Terrₙ, thereby coinciding the timing with the ideal ON timing TRₙ.

### Second Embodiment

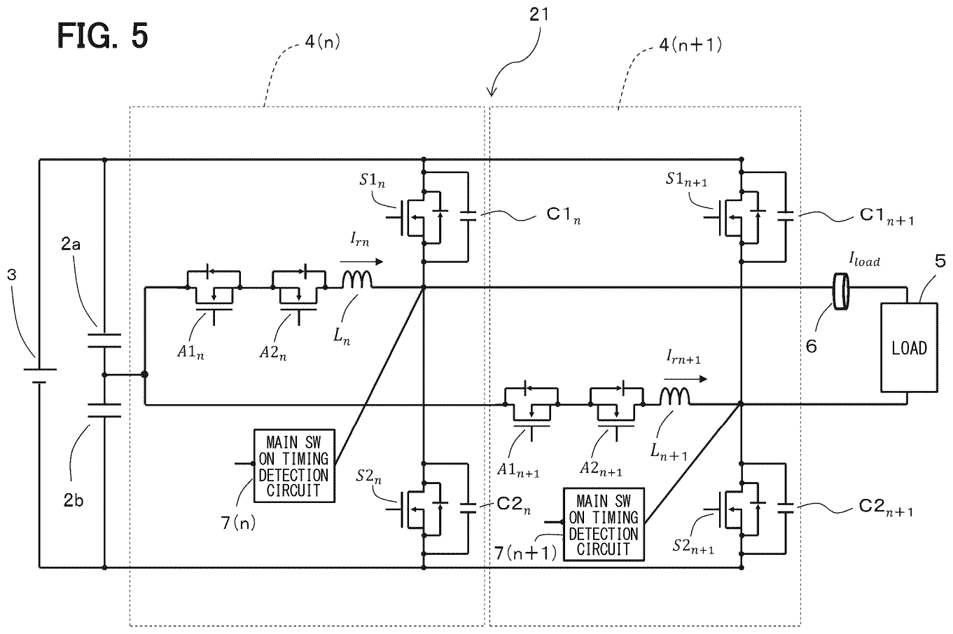

Hereinafter, the same reference numerals are assigned to components identical to those in the first embodiment, and their description is omitted; only the different parts will be described. As shown in FIG. 5, in a power circuit 21 of the second embodiment, main SW ON timing detection circuits 7(n) and 7(n+1), are connected to the output terminals of leg 4(n) and leg 4(n+1), respectively.

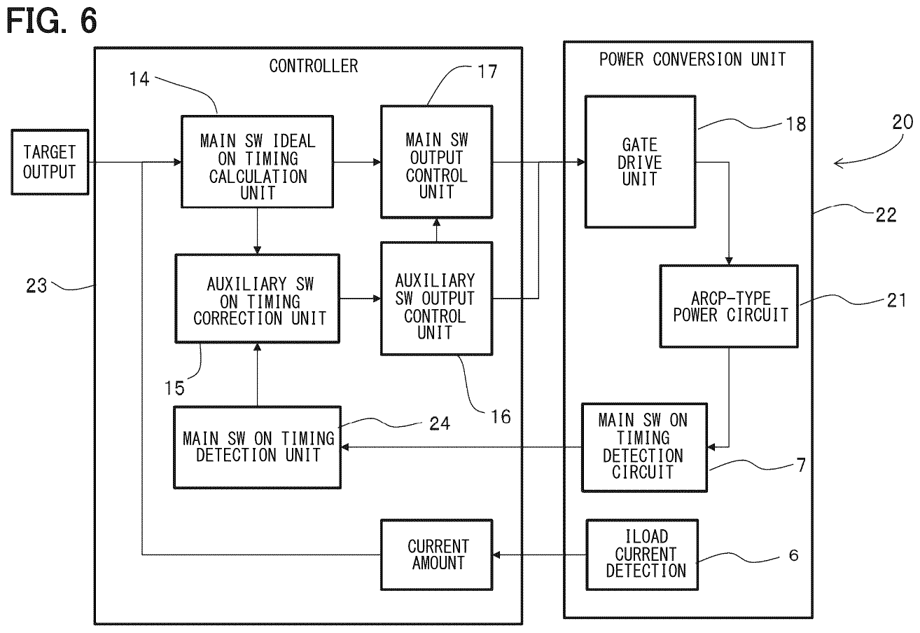

As shown in FIG. 6, the power converter 20 includes a power conversion unit 22 and a controller 23. The power conversion unit 22 includes the power circuit 21. The main SW ON timing detection unit 24 of the controller 23 receives detection signals indicating the ON timing of the main switches S1 and S2 from the main SW ON timing detection circuit 7 of the power circuit 21. The ON timing of the main switches S1 and S2 detected by the main SW ON timing detection unit 24 is input to the auxiliary SW ON timing correction unit 15. The auxiliary SW ON timing correction unit 15 corrects the ON timing of the auxiliary switches A1 and A2 based on the input signals, and performs additional correction as described later, then outputs the correction information to the auxiliary SW output control unit 16. The auxiliary SW output control unit 16 also outputs the switching control signals for the auxiliary switches A1 and A2 to the main SW output control unit 17.

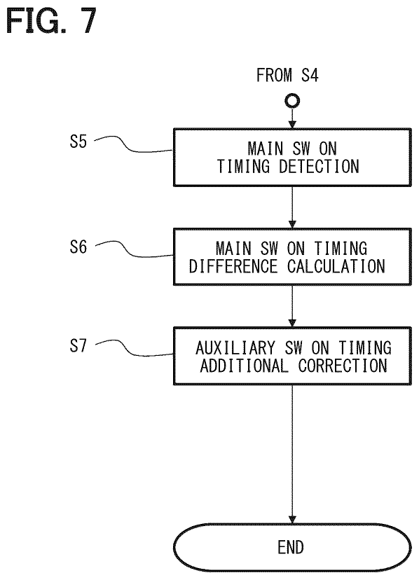

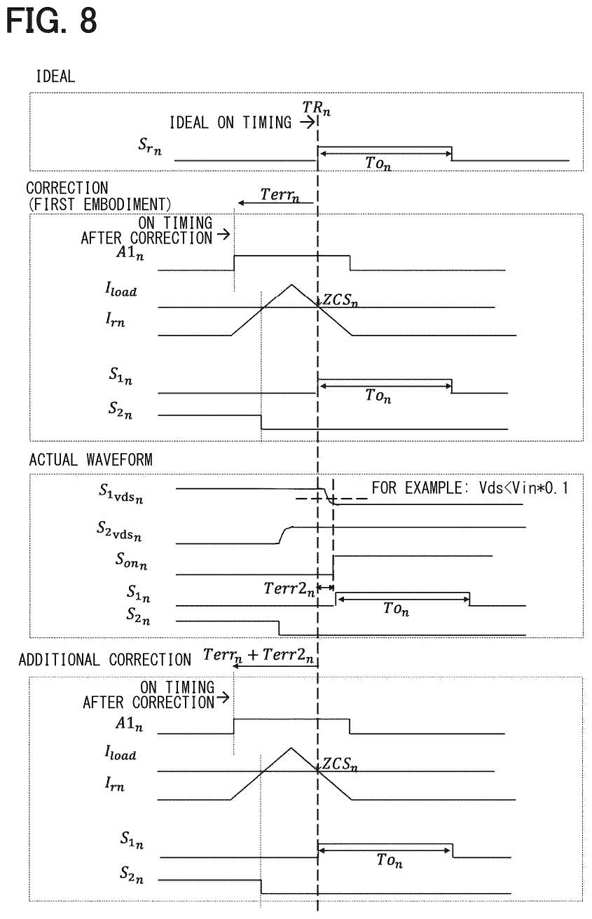

Next, the operation of the second embodiment will be described with reference to FIGS. 7 and 8. The flowchart shown in FIG. 7 is executed following S1 to S4 of the first embodiment. When S4 is executed, the main SW ON timing detection unit 24 of the controller 23 detects the actual ON timing Sonₙ, which is the result of the operation of the main switches Sin and S2ₙ in real time in S5 shown in FIG. 7. For example, the drain-source voltage Vds of the main switches S1ₙ and S2ₙ is measured, and the actual ON timing Sonₙ is detected at the moment when the voltage Vds falls below a threshold, which is set, for example, at 10% of the input voltage Vin. When the polarity of the output current is positive, the drain-source voltage Vds of the main switch S1ₙ is used; and when the polarity is negative, the drain-source voltage Vds of the main switch S2ₙ is used.

Subsequently, the difference Terr2ₙ between the actual ON timing Sonₙ and the ideal ON timing TRₙ is detected in S6, and additional correction is performed by the auxiliary SW ON timing correction unit 15 in S7 shown in FIG. 7. As a result, as shown in the timing chart of “Additional Correction” in FIG. 8, even if there is a difference between the actual ON timing Sonₙ and the ideal ON timing TRₙ after the correction according to the first embodiment, the ON timing of the main switches Sin and S2ₙ can be made to coincide with the ideal ON timing.

### Third Embodiment

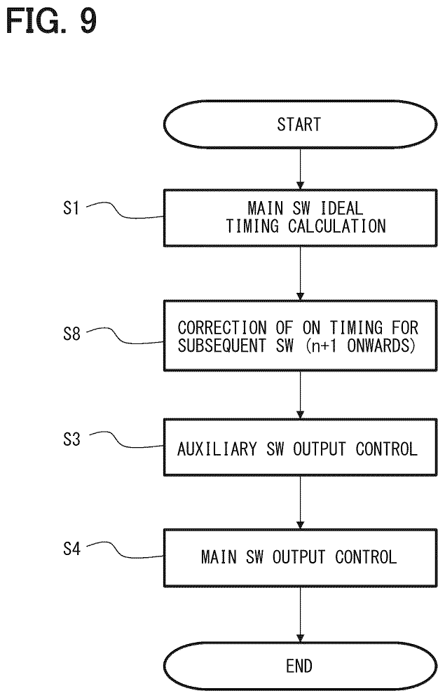

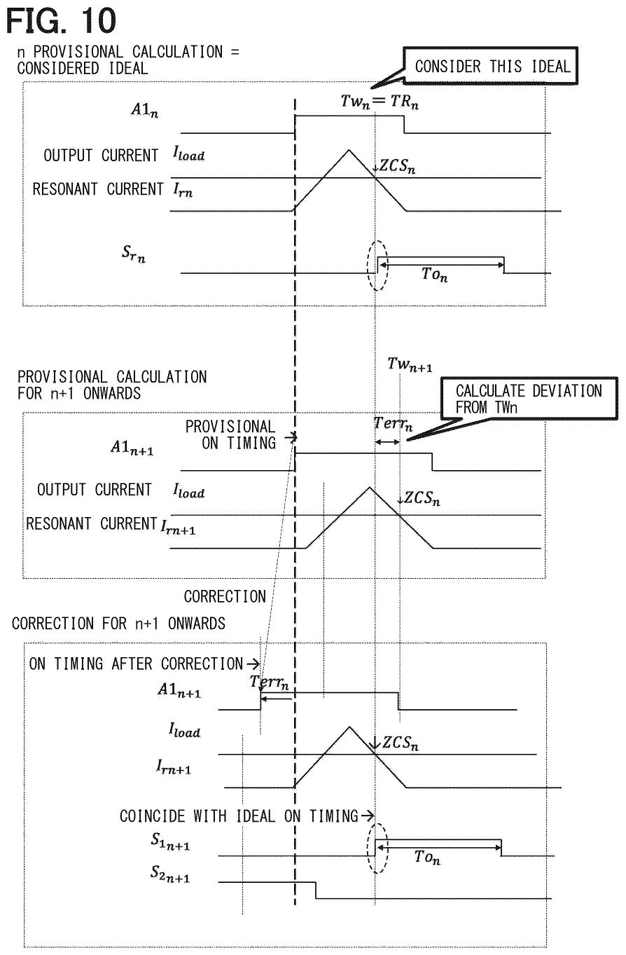

The configuration of a third embodiment is the same as that of the first embodiment, but the control content is different. As shown in FIGS. 9 and 10, in the third embodiment, S8 is executed instead of S2. In other words, in the leg 4(n), the timing of the auxiliary switches A1ₙ and A2ₙ is not corrected. Instead, the difference between the ideal ON timing TRₙ and the provisionally calculated optimal SW timing Twn+1 for the legs 4 from (n+1) onwards is calculated as Terrₙ. Based on this difference Terrₙ, the timing of the auxiliary switches A1 and A2 in the legs 4 from (n+1) onwards is corrected.

In the third embodiment, the leg 4 (n) corresponds to the master leg, and the leg 4 (n+1) corresponds to the slave leg. Even when control is performed in this manner, the ON time ratio of the main switches S1 and S2 among the respective legs 4 can be corrected to achieve the intended ratio.

### Fourth Embodiment

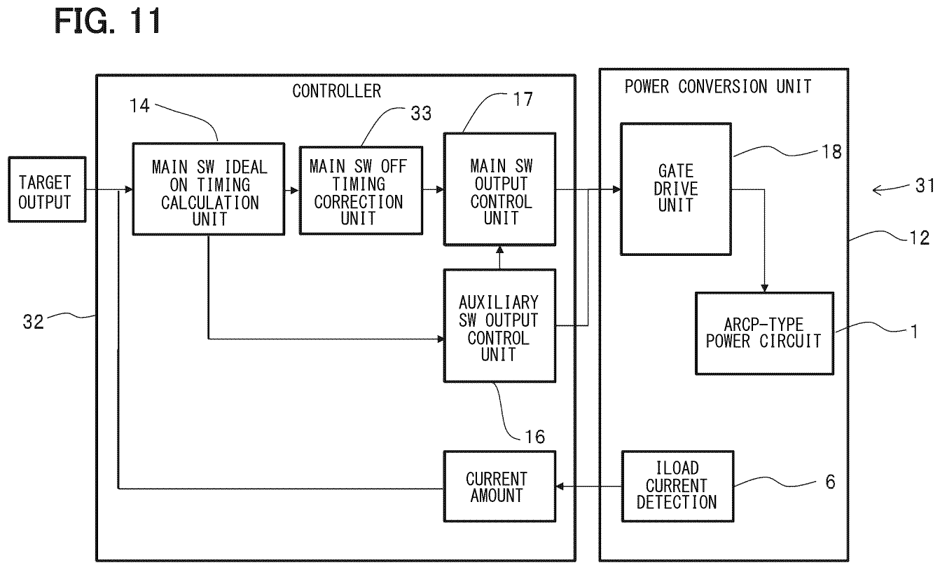

As shown in FIG. 11, a power converter 31 of the fourth embodiment is provided with a controller 32 in place of the controller 13 of the power converter 11 in the first embodiment. In the controller 32, the auxiliary SW_ON timing correction unit 15 has been removed, and instead, a main SW_OFF timing correction unit 33 is provided between the main SW ideal ON timing calculation unit 14 and the main SW output control unit 17.

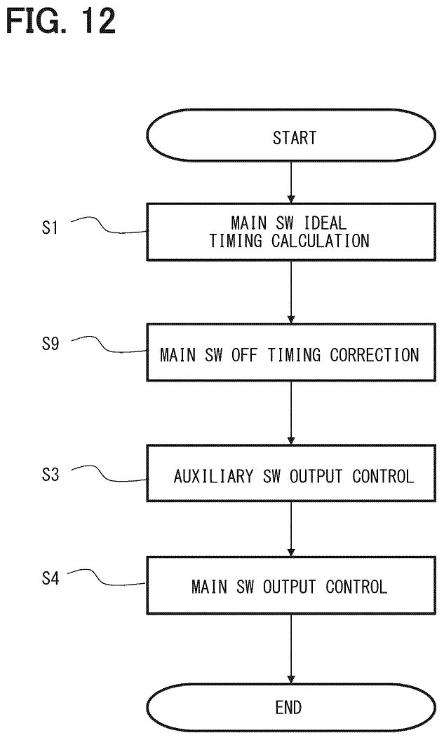

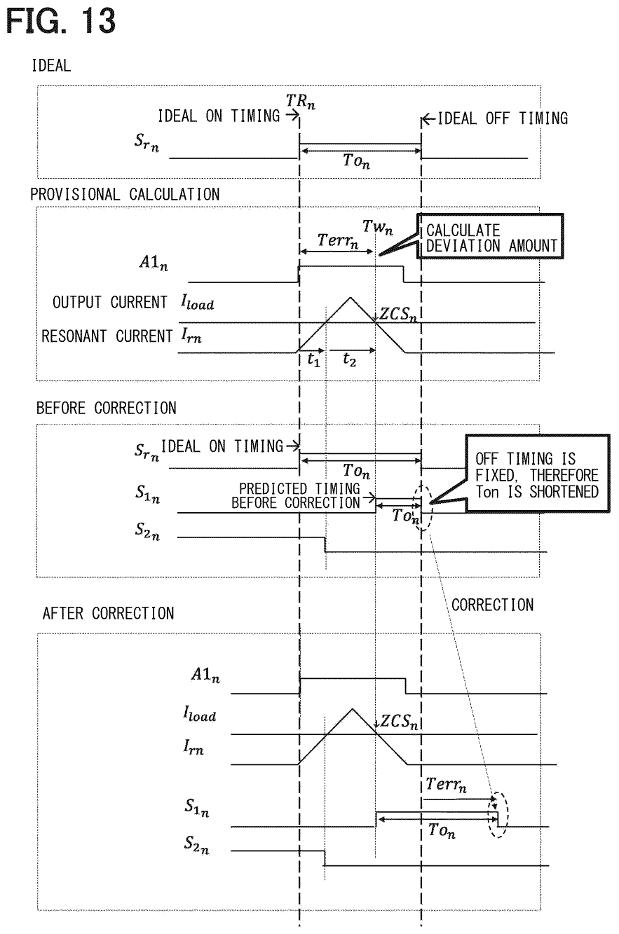

Next, the operation of the fourth embodiment will be described with reference to FIGS. 12 and 13. As shown in FIG. 12, in the fourth embodiment, S9 is executed instead of S2 to correct the OFF timing of the main switches S1 and S2. The first to third embodiments employ control based on the premise that the OFF timing of the main switches S1 and S2 is fixed.

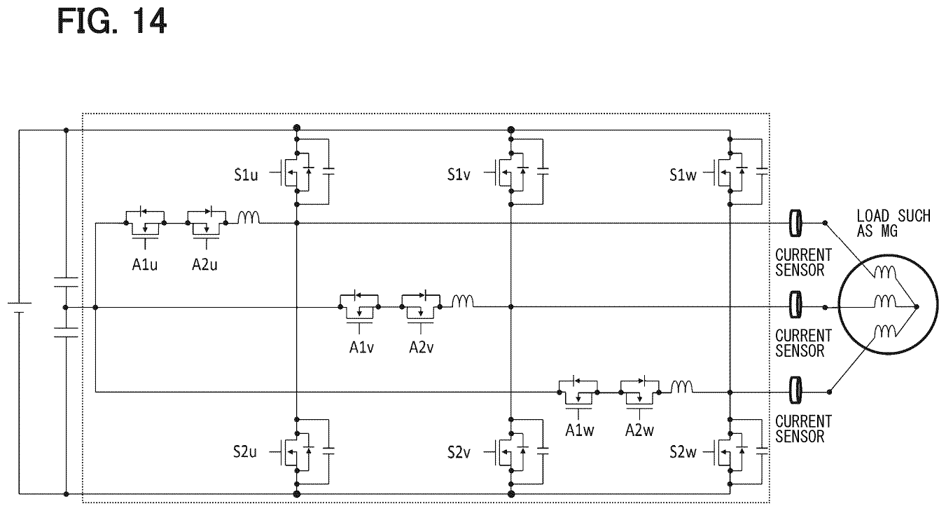

In contrast, in the fourth embodiment, as shown in FIG. 14, the main SW_OFF timing correction unit 33, similarly to the first embodiment, calculates the difference Terrₙ between the provisionally calculated optimal SW timing Twₙ and the ideal ON timing TRₙ. Based on this difference Terrₙ, the OFF timing of the main switches S1 and S2 is corrected. Even when control is performed in this manner, the ON-time ratio of the main switches S1 and S2 among the respective legs 4 can be corrected to achieve the intended values.

### Other Embodiments

FIG. 14 shows a configuration in which the load is a three-phase motor, and accordingly, the power conversion unit is provided with three legs 4. Furthermore, the number of legs 4 may be “four” or more. Each switch is not limited to an N-channel MOSFET. The present disclosure has been described in accordance with the embodiments, but it is understood that the present disclosure is not limited to these embodiments or structures. The present disclosure also encompasses various modifications and alterations within the scope of equivalents. In addition, various combinations and configurations, as well as other combinations and configurations including only one element, more than one, or fewer than one of those elements, are also within the scope and spirit of the present disclosure.

In the present disclosure or the claims, the term “processor” may refer to a single hardware processor or several hardware processors that are configured to execute processing defined by computer program code (i.e., one or more instructions of a computer program) by sequentially reading the computer program code included in a computer program. In other words, a “processor” is a hardware device that executes one or more program processes. Therefore, the computer program code can be considered software that defines the processing of the processor according to its content. The “processor” may be a general-purpose or specific-purpose processor, such as, CPU (Central Processing Unit), a microprocessor, GPU (Graphics Processing Unit) and DFP (Data Flow Processor), but is not limited to these examples.

In the present disclosure or the claims, the term “memory” is a non-transitory tangible storage medium and may refer to a single or several hardware memories configured to store computer program code and/or data in a manner accessible by the processor. The “memory” may be implemented using any suitable memory technology, such as SRAM (Static Random-access Memory), SDRAM (Synchronous Dynamic RAM), nonvolatile/flash memory, or other types of memory. The computer program code that constitutes the program is stored on the memory and, when executed by a processor, causes the processor to realize the various functions described above.

In the present disclosure or the claims, the term “circuit” refers to a single hardware logic circuit or several hardware logic circuits (in other words, “circuitry”) that are configured to execute specific processing defined based on a pre-designed circuit configuration. In other words (and in contrast to the “processor”), the term “circuit” in the present disclosure or the claims refers to a hardware device that executes specific processing based on a circuit configuration, not processing defined by software such as the above-described computer program code. For instance, “circuit” may include a custom IC (Integrated Circuit) such as ASIC (Application Specific Integrated Circuit) or FPGA (Field Programmable Gate Array) designed using a hardware description language (HDL). That is, the term “circuit” in the present disclosure or the claims includes all hardware circuits except the above-described processor that executes processing by reading computer program code.

In the present disclosure or the claims, the phrase “at least one of a circuit and a processor” should be interpreted disjunctively (logical OR) and should not be interpreted as at least one circuit and at least one processor. Therefore, in the present disclosure or the claim, “at least one of a circuit and a processor is configured to cause the power converter to execute functions” includes the case where only the circuit causes the power converter to execute all the functions. Additionally, “at least one of a circuit and a processor is configured to cause the power converter to execute functions” includes the case where only the processor causes the power converter to execute all the functions. Furthermore, “at least one of a circuit and a processor is configured to cause the power converter to execute functions” includes the case where the circuit causes the power converter to execute some of the functions and the processor causes the power converter to execute the remaining functions. In the last case, for instance, if the power converter executes functions A to C, functions A and B may be implemented by the circuit, and the remaining function C may be implemented by the processor.

What is claimed is:

1. A power converter comprising:
a power conversion unit including legs, each leg including:
a first series connection of a high-potential side main switch and a low-potential side main switch, the high-potential side main switch and the low-potential side main switch being collectively referred to as a main switch;
resonance capacitors connected in parallel to the high-potential side main switch and the low-potential side main switch, respectively; and
a second series connection of two auxiliary switches and a resonance inductor, the two auxiliary switches being two transistors forming a bidirectional switch, the two transistors having commonly connected drains or emitters, the second series connection having a first end and a second end, the first end connected to a common connection node between the high-potential side main switch and the low-potential side main switch, the second end connected to a common node, the two auxiliary switches being collectively referred to as an auxiliary switch; and
a controller configured to control switching of each switch included in the power conversion unit by:
controlling each of the legs to execute soft switching; and
correcting a timing for switching the main switch or the auxiliary switch, such that an ON-time ratio of the main switch among the legs attains a predetermined ratio.

2. The power converter according to claim 1, wherein
the controller is further configured to:
calculate a turn-on time and an ideal ON timing of the main switch to acquire a target output from the power conversion unit;
control switching of the main switch based on the turn-on time and the ideal ON timing;
correct an ON timing of the auxiliary switch, the ON timing being a preset timing;
execute switching control of the auxiliary switch based on the corrected ON timing;
calculate an ON timing delay time of the main switch based on a switching operation of the auxiliary switch; and
correct the ON timing of the auxiliary switch based on the calculated ON timing delay time.

3. The power converter according to claim 2, wherein
the controller is further configured to:
detect an actual ON timing of the main switch in the power conversion unit; and
execute an additional correction of the ON timing of the auxiliary switch, such that the actual ON timing coincides with the ideal ON timing.

4. The power converter according to claim 1, wherein
one of the legs is a master leg,
another one of the legs is a slave leg,
the controller is further configured to:
calculate a turn-on time and an ideal ON timing of the main switch in each of the legs to acquire a target output from the power conversion unit;
execute switching control of the main switch based on the turn-on time and the ideal ON timing;
correct an ON timing of the auxiliary switch in the slave leg based on the ideal ON timing, the ON timing being a preset timing;
execute switching control of the auxiliary switch in the slave leg based on the corrected ON timing;
calculate a difference between the ideal ON timing in the master leg and an ideal ON timing in the slave leg; and
correct the ON timing of the auxiliary switch in the slave leg based on the difference.

5. The power converter according to claim 1, wherein
the controller is further configured to:
calculate a turn-on time and an ideal ON timing of the main switch to acquire a target output from the power conversion unit;
execute switching control of the main switch based on the turn-on time and the ideal ON timing;
execute switching control of the auxiliary switch;
calculate an ON timing delay time of the main switch based on a switching operation of the auxiliary switch; and
correct an OFF timing of the main switch based on the ON timing delay time.
